(19) United States
(12) Patent Application Publication
(10) Pub. No.: US 2026/0017394 A1
(43) Pub. Date: Jan. 15, 2026

(54) SECURE LOCATION AUTHENTICATION

(71) Applicant: Lenovo Global Technology (United States) Inc., Morrisville, NC (US)

(72) Inventors: Rinawl Ronald Sequeira, Milton (CA); Robert James Norton, JR., Raleigh, NC (US); Zachary Ransom, Denver, CO (US)

(21) Appl. No.: 18/766,984

(22) Filed: Jul. 9, 2024

(51) Int. Cl. G06F 21/62

(52) U.S. Cl. CPC G06F 21/6218; G06F 2221/2141

(57) ABSTRACT

One embodiment provides a method, the method including: receiving, utilizing a location authentication system, a request from a user to access information required to be accessed from a secure location; determining, utilizing the location authentication system, the request has been received from the secure location utilizing at least one of a plurality of location authentication techniques available at the secure location, wherein each of the plurality of location authentication techniques includes capturing information using sensors located at the secure location; and granting, utilizing the location authentication system and responsive to determining the request has been received from the secure location, access to the information to the user. Other aspects are claimed and described.

### BACKGROUND

Keeping sensitive information private is extremely important. Different companies and entities have access to personal sensitive information of people (e.g., social security numbers, addresses, phone numbers, birthdates, etc.) for a variety of reasons. Additionally, companies and entities may produce and have their own sensitive information, for example, proprietary documents, confidential information, and/or the like. Different documents or information may have varying level of security requirements. For example, higher-level security requirements may require extra security measures as compared to lower-level security requirements. Some security measures may include requiring user credentials to access the information, requiring biometric scans to access the information, and/or the like. Some higher-level security measures may include requiring the information to be accessed from a particular secure location. In this case, the information can only be accessed from the secure location and cannot be accessed from a different location.

### BRIEF SUMMARY

In summary, one aspect provides a method, the method including: receiving, utilizing a location authentication system, a request from a user to access information required to be accessed from a secure location; determining, utilizing the location authentication system, the request has been received from the secure location utilizing at least one of a plurality of location authentication techniques available at the secure location, wherein each of the plurality of location authentication techniques includes capturing information using sensors located at the secure location; and granting, utilizing the location authentication system and responsive to determining the request has been received from the secure location, access to the information to the user.

Another aspect provides a system, the system including: sensors located at a secure location; a processor operatively coupled to the sensors; a memory device that stores instructions that, when executed by the processor, causes the system to: receive, utilizing a location authentication system, a request from a user to access information required to be accessed from a secure location; determine, utilizing the location authentication system, the request has been received from the secure location utilizing at least one of a plurality of location authentication techniques available at the secure location, wherein each of the plurality of location authentication techniques includes capturing information using the sensors located at the secure location; and grant, utilizing the location authentication system and responsive to determining the request has been received from the secure location, access to the information to the user.

A further aspect provides a product, the product including: a computer-readable storage device that stores executable code that, when executed by a processor, causes the product to: receive, utilizing a location authentication system, a request from a user to access information required to be accessed from a secure location; determine, utilizing the location authentication system, the request has been received from the secure location utilizing at least one of a plurality of location authentication techniques available at the secure location, wherein each of the plurality of location authentication techniques includes capturing information using sensors located at the secure location; and grant, utilizing the location authentication system and responsive to determining the request has been received from the secure location, access to the information to the user.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for determining that a request for accessing information has been received from a secure location and, upon determining that the request has been received from the secure location, granting access to the information.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

There are many different techniques that have been developed to determine that a user who is attempting to access information that requires at least one security measure be passed before access to the information is granted, also referred to secure information. Different authentication techniques (e.g., the method for identifying the person who is attempting to access the secure information) are considered stronger than others. Stronger authentication techniques generally delineate techniques that are more difficult to spoof or trick than weaker authentication techniques. Depending on the security level or sensitivity of the information, the required strength of the authentication technique may vary. Additionally, some information that may have a very high security level may require the use of multiple authentication techniques. Some example authentication techniques include, but are not limited to, provision of user credentials (e.g., username, password, etc.), biometric scans (e.g., fingerprint scan, retinal scan, etc.), voice matching, two-factor authentication which requires the provision of a secret code, facial recognition, and/or the like.

Additionally, during an authenticated session, which is a session where the user has been granted access to requested information, some authentication techniques can be run periodically to ensure different attributes of the user. Generally, these authentication techniques are referred to as continuous authentication and are performed using techniques that may not specifically identify the person, but rather may identify an attribute of a person, for example, whether the entity accessing the information is a live person, whether the entity accessing the information matches some general attributes of the expected person (e.g., height, shape, voice profile, movement profile, etc.), whether the entity accessing the information is looking at the information, and/or the like. These techniques can ensure that an entity accessing the information is the same entity that was granted access to the information at the beginning of the authenticated session.

To further secure information, some information can only be accessed from a particular location which has been identified as a secure location. A secure location may be one that has been identified by an entity that is responsible for the security of information. For example, some secure information can only be accessed using a specific information handling device (e.g., computer, tablet, smart phone, laptop computer, etc.) and the specific information handling device may be located at a particular location within a building, for example, in a room that requires additional verification information to enter. As another example, some information may only be able to be accessed from a room having no windows and with no other people in the room. However, there may be multiple rooms that fit this criteria, so a user could access the information from any of these rooms fitting the criteria.

Traditionally, to ensure that information is being accessed from a secure location, geofencing is utilized. Using geofencing, a virtual barrier is put around a secure location and, if a user is attempting to access the information from a location that is not within the virtual barrier, the user is barred from accessing the information. If, on the other hand, the user is within the virtual barrier, the user is permitted access to the information, assuming the user meets all the other requirements for accessing the secure information. One common method for ensuring a user is within the geofenced location requires the use of global positioning system (GPS) data captured from a device. The GPS data is compared to the location of the geofence and access is authorized or denied based upon the comparison. However, some secure locations do not have consistent or reliable GPS signals, meaning that a user may be in a secure location but due to the unreliable GPS signals, the system cannot determine that the user is actually within the geofenced area and may deny access to the user. Alternatively, the user may be granted access and then lose the GPS signal and be locked out of access to the information.

Accordingly, the described system and method provide a technique for determining that a request for accessing information has been received from a secure location and, upon determining that the request has been received from the secure location, granting access to the information. Additionally, the described system and method can identify that an authorized user is providing the request to access the information. Additionally, the described system and method can be utilized as a continuous authentication technique to verify the user during the authenticated session. The system receives a request from a user to access information that is required to be accessed from a secure location. The secure location may be one of a plurality of secure locations. In other words, the information may be able to be accessed from more than one secure location.

In response to the request, the system determines if the request has been received from the secure location, or, in the case of the availability of multiple secure locations, one of the secure locations. To make this determination, the system utilizes at least one of a plurality of location authentication techniques available at the secure location. In other words, each secure location has multiple location authentication techniques that can be utilized to determine if the request has been received from the secure location. For each of these location authentication techniques, the system captures information utilizing sensors that are located at the secure location. Each of the techniques may utilize separate sensors, sensors that may be utilized between multiple of the authentication techniques, a combination of sensors, and/or the like. The authentication techniques may be location authentication techniques that do not rely on geofencing. Upon determining that the request has been received from a secure location, the system grants access to the information being requested. Before granting access, the system may also require that the user be authenticated as a person having access to the requested information.

Therefore, a system provides a technical improvement over traditional methods for identifying that information is being accessed from a secure location. Traditional systems rely on geofencing which requires an active GPS signal to ensure a user is at the secure location. However, due to weak, inconsistent, and unreliable GPS signals at some locations, a user may be locked out of access to information even if the user should be able to access the information. The described systems and methods rely on sensors that are located locally at the secure location to determine that a user providing a request to access the information is currently located at the secure location. Thus, the described system and method relies on more reliable technology that is located at the secure location, thereby providing a more reliable technique for determining that a request has been received from a secure location as compared to conventional techniques. Additionally, the described system and method provides a technique for performing continuous authentication using the sensors located at the secure location, thereby providing an alternative technique for performing continuous authentication as compared to traditional continuous authentication techniques.

The illustrated example embodiments will be best understood by reference to the figures. The following description is intended only by way of example, and simply illustrates certain example embodiments.

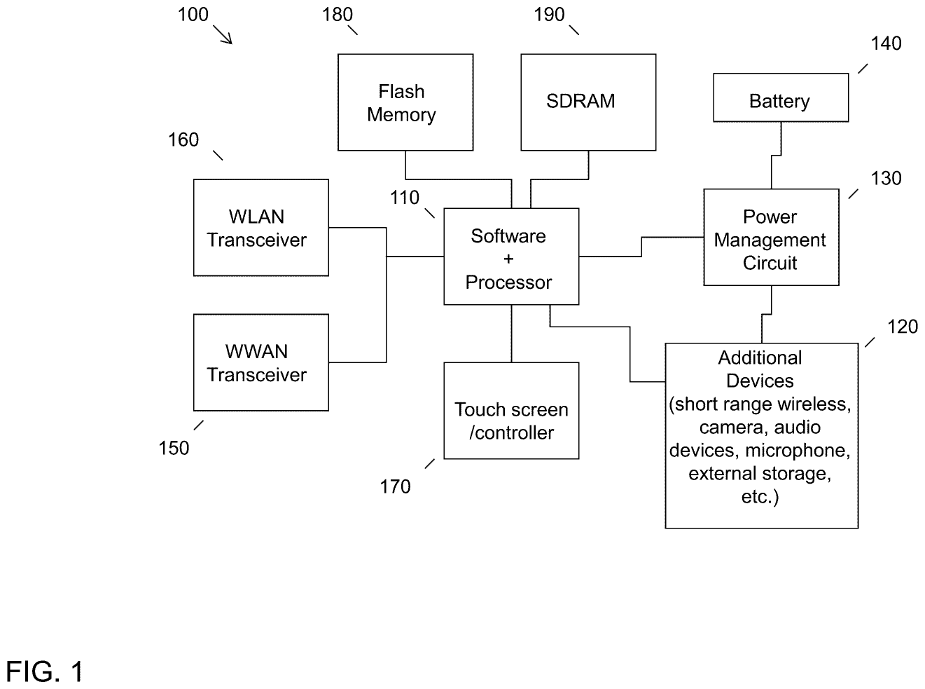

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

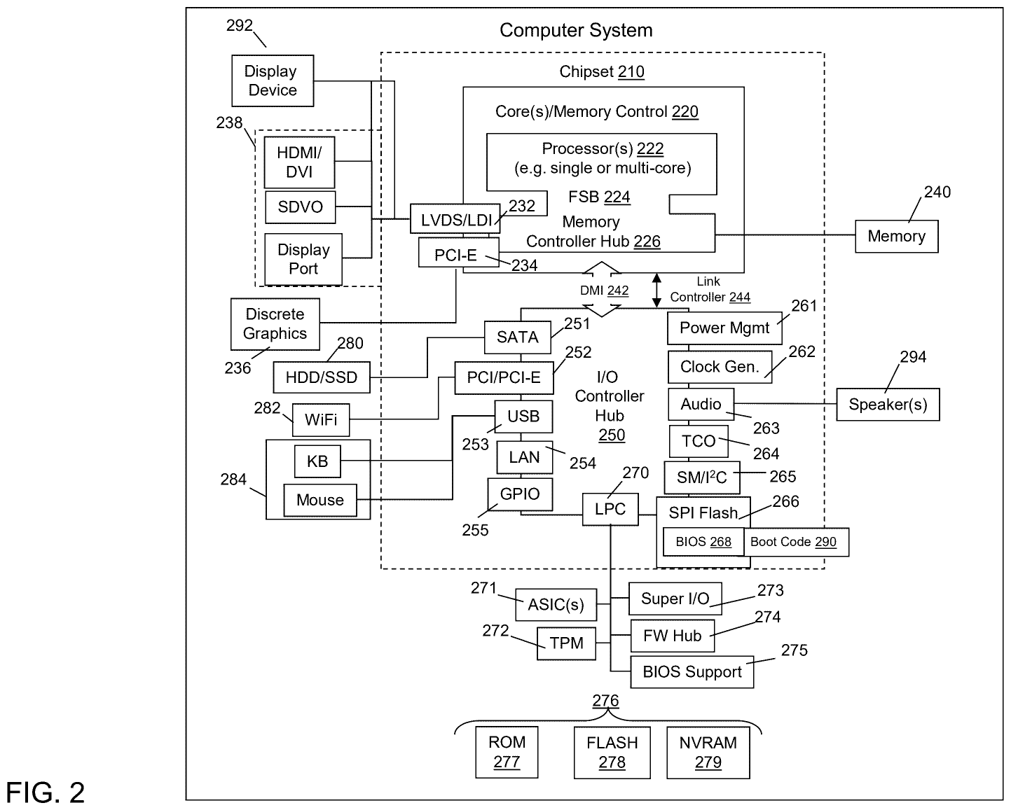

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used in devices or systems to determine if a request to access information has been received from a secure location. For example, the circuitry outlined in FIG. 1 may be implemented in a tablet or smart phone embodiment, whereas the circuitry outlined in FIG. 2 may be implemented in a personal computer embodiment.

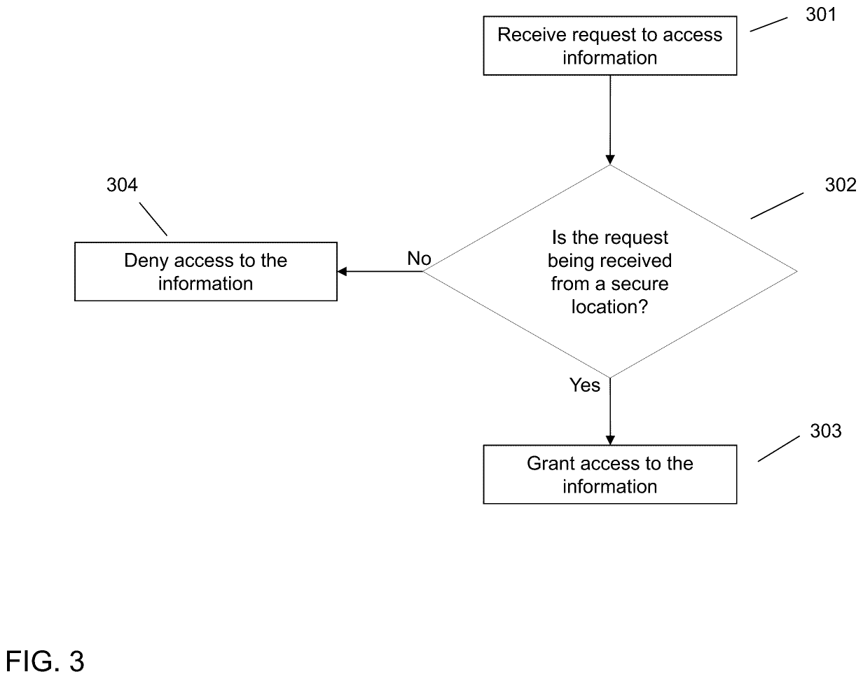

FIG. 3 illustrates an example method for determining that a request for accessing information has been received from a secure location and, upon determining that the request has been received from the secure location, granting access to the information. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to determine that a request to access information has been received from a secure location. Additionally, the location authentication system includes modules and features that are unique to the described system.

The activation of the location authentication system may be manual, where a user provides an input indicating that the location authentication system should be activated, or automatic where the location authentication system detects a trigger event indicating that the system should be activated. Example trigger events include detection of a person or other entity near, at, or within a secure location, activation of software or an application connected to or in communication with the location authentication system (e.g., instruction set provision application, task queue application, etc.), and/or the like. For example, the system may detect that a person has entered a secure location, identify this as a trigger event, and may thereafter activate the location authentication system. As another example, a user may provide a request to access secure information that is required to be accessed from a secure location, the system may identify this as a trigger event, and may thereafter activate the location authentication system.

The location authentication system may be a standalone system, may be accessible through other computing devices, and/or a combination thereof. For example, the location authentication system may be a standalone system that can be accessed by a user and/or may be or provide an application that is accessible by a user on another computing device. The location authentication system may be accessible using any type of computing device, for example, personal computer, laptop computer, smartphone, tablet, smartwatch, head-mounted display, smart television or other smart appliance, augmented reality device, virtual reality device, and/or the like. Thus, the location authentication system may be accessible locally using a computing device where the location authentication system is installed and/or may be accessible remotely through another computing device. For example, the location authentication system may be accessed by a user or other entity to access user profiles, location authentication technique setups, location authentication sensors or components, and/or the like. However, the location authentication system may be located and operate on a different information handling device to perform the described steps.

The location authentication system may have an associated graphical user interface. The graphical user interface may be provided on a display or monitor, which may or may not be associated with the location authentication system. In other words, the location authentication system may have a dedicated display or monitor or may be accessible using any display or monitor. In either case, the location authentication system may provide instructions to generate and display the graphical user interface on the display device being used to access the location authentication system. The graphical user interface may also be updated and managed based upon instructions provided by the location authentication system. In other words, the location authentication system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the location authentication system. For example, the location authentication system may utilize a user profile to identify characteristics of the user. The graphical user interface may allow for creation of this user profile by allowing a user to input information regarding the user and/or the like. As will be discussed in more detail, the use of user provided information is not the only way that the user profile can be created. The location authentication system can then utilize these inputs to create the user profile. A user could also use the graphical user interface to adjust information within the user profile.

A user may also use the graphical user interface to identify secure locations, profiles of secure locations, including sensors at the secure location, location authentication techniques that can be used at the secure location, a number of authentication techniques that need to be matched for the authentication, information accessible at the secure location, and/or the like. Additionally, or alternatively, the user can input a location housing or storing information related to a user profile, secure location, location authentication techniques, and/or the like, within the graphical user interface. Input may be provided by the user using any type of input modality, including, but not limited to, mechanical input (e.g., keyboard input, mouse input, etc.), touch input, audible or voice input, gesture input, haptic input, and/or the like.

The graphical user interface may also provide displays that display information of the user profiles, secure location profiles, and/or the like. It should be noted that the information to be used by the location authentication system and information provided by the location authentication system can be different for different applications, different computing systems, different users, and/or the like. Thus, the information corresponding to input or output of the location authentication system are not always the same. However, the location authentication system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The location authentication system may utilize one or more artificial intelligence models in creating user profiles, authenticating that a request has been received from a secure location, performing continuous authentication using the location authentication techniques, and/or any other steps included in the system or method. Artificial intelligence models may also be used for steps within a step. For example, a model could be utilized to match captured attributes with a user profile to authenticate a user, to identify which location authentication techniques to utilize for a secure location, and/or the like. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the location authentication system or may be a model that is created from scratch. Since the location authentication system is used in conjunction with authenticating users and determining if a request has been received from a secure location, some models that may be utilized by the system are text analysis models, image analysis models, audio analysis models, similarity identification models, large language models, filtering models, classification models, and/or the like. The model may be trained using one or more training datasets. Additionally, as the model is deployed, it may receive feedback to become more accurate over time. The feedback may be automatically ingested by the model as it is deployed. For example, as the model is used to authenticate a user or determine if a request has been received from a secure location, if a user identifies that an authentication made by the model is incorrect, that secure location determination was incorrect, or otherwise provides some indication that the predictions or selections made by the model may be incorrect, the model ingests this feedback to refine the model.

On the other hand, as the model authenticates users, determines requests have been received from a secure location, and/or the like, and no changes are made to the authentication, secure location determination, and/or the like, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The location authentication system may include different components for carrying out different functions of the system, including different steps to be performed. These components may be hardware components or software components. Some hardware components may include sensors (e.g., biometric sensors, image capture devices, proximity sensors, microphones, accelerometers, activity trackers, health metric sensors, etc.) that can be used to identify a user, authenticate a user, determine that a request has been received from a secure location, identify gestures provided by a user, capture audio provided by the user, and/or the like. Other input devices may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the location authentication system. For example, the location authentication system may include speakers, displays or monitors, haptic output devices, audio output devices, and/or the like.

One software component that is utilized in the system is the profile of the user, or user profile. The user profile includes previously stored characteristics or attributes of a user that can be used for identifying and/or authenticating a user. The characteristics or attributes of a user that are stored within the user profile may be based upon the sensors that are accessible at a particular secure location. For example, if a secure location accessible by a user does not have a technique for capturing a radio frequency identification (RFID) tag of a user, the user profile may not include information regarding RFID tags that may be assigned to a user. Additionally, if a user does not have a particular characteristic, even if able to be captured within a secure location, the user profile may not include that characteristic. For example, if a user does not have an assigned RFID tag, the user profile will not include information corresponding to an RFID tag. Alternatively, or additionally, the user profile may include characteristics and attributes of the user that are known, regardless of whether these characteristics and/or attributes can be used by the system in a location authentication technique for one or more secure locations.

To create a user profile, the system can be set into a training mode. The training mode allows the system to capture characteristics of the user as the user is within a secure location or other location. Depending on the characteristic that is being captured for the user profile, the user may or may not need to be within a secure location. For example, characteristics that are captured using a device of the user (e.g., activity tracker, O₂ sensor, heart rate tracker, smart phone, accelerometer, gyroscope, smart watch, etc.), can be captured at any time or in any space where the user has the device. On the other hand, characteristics that are captured using sensors or components of a secure location, can be captured when the user is within the secure location. While the sensors or components are able to capture the characteristics of the user, the information can be provided to the system.

The system can utilize this information to learn characteristics and patterns of the user that can be added to the user profile. For example, if the sensor or device captures a heart rate of the user, the system can learn a heart rate pattern of a user, for example, the heart rate pattern of a user when the user is performing a particular task, and add the heart rate pattern to the user profile. Characteristic and pattern learning can be enabled using one or more artificial intelligence models. Other techniques are contemplated and possible, including, but not limited to, capture and storage of raw characteristic data, traditional health metric analysis, and/or the like.

The user profile can also be updated utilizing techniques other than automatic or learned techniques. One such technique includes a user manually providing characteristic or attribute information into the user profile, for example, using the graphical user interface. The user may also upload or otherwise provide a set of characteristic or attribute information to the system and the system may then derive the characteristic or attribute information to put into the user profile. For example, the user may have an activity tracker that tracks health metrics over time. Instead of the system tracking this information, the user can provide the information captured by the activity tracker to the system. The system can then derive the characteristic or attribute information from the provided captured information. Other techniques for updating the user profile are contemplated and possible.

The user profile may be utilized by the system to make determinations regarding whether a user request is being received from a secure location. The user profile may also be utilized by the system to perform continuous or secondary authentication of the user during an authenticated session. Continuous authentication is authentication of a user that occurs periodically during an authenticated session. An authenticated session is a session where the user has access to the requested information after the user has been authenticated or otherwise granted access to the information. Continuous or secondary authentication may include authentication that occurs constantly, or may include authentication that occurs at other than constant frequencies throughout the authenticated session. The other than constant frequencies may include predetermined intervals of time, for example, every few seconds, every few minutes, a few times an hour, every hour, and/or the like. Since the secondary authentication occurs until the user leaves the secure location, even though the secondary authentication may be performed at predetermined intervals, this is still considered continuous authentication, even though it is not a constant authentication. The frequency or length of the predetermined time intervals may be a default value, set by a user, set by an administrator of the system, set by a different entity, and/or the like.

It should also be noted that the frequency or length of the predetermined time intervals may be different for different use cases, may be different based upon a sensitivity of the secure location, may be different for different users, may be different based upon a sensitivity or security level of the information being accessed, and/or the like. For example, a highly restricted space may perform constant secondary authentication, while a less restricted space may be set to perform secondary authentication at a lower frequency. As another example, secondary authentication performed using a device that is powered using a power plug may perform secondary authentication at a higher frequency than secondary authentication performed using a device that is powered using a battery.

Another software component is a secure location profile. The secure location profile may identify the sensors and other components that are accessible at the secure location. The secure location profile may identify the location authentication technique(s) that are available at the secure location. Each of the location authentication techniques may require different components. Thus, secure locations that do not have a particular component for a location authentication technique, will not have that location authentication technique as an available technique for determining a request to access information has been received from a secure location. The secure location profile may also define how many location authentication techniques that are available at the secure location have to be matched to determine a positive result regarding whether the request was received from a secure location. In other words, rather than utilizing a single location authentication technique to determine the request has been received from a secure location, the system or secure location profile may require that more than one location authentication technique is matched to determine the request has been received from a secure location.

Identifying how many location authentication techniques need to be matched may be based upon the number of location authentication techniques available at the secure location. The number of techniques that need to be matched may simply be a particular number of the location authentication techniques. Additionally, or alternatively, the number of techniques that need to be matched may be a particular percentage or particular fraction of the available location authentication techniques. For example, the system may require that three out of the possible five location authentication techniques have to match before the system will determine that the request was received from a secure location. As another example, the system may require that a majority of the possible location authentication techniques have to match before the system will determine that the request was received from a secure location. The number of techniques that have to match can be set based upon user, information, default values, secure location, and/or the like.

Different information may require a different number of matches for a number of location authentication techniques. For example, information may have a corresponding security level which identifies how sensitive the information is or how secure the information needs to be kept. Higher security levels generally indicate that the information needs to be kept more secure than lower security levels. Additionally, higher security levels generally have a fewer number of people or groups that can access the information as compared to lower security levels. Each of the security levels may have a corresponding security access level that is associated with the user who can access the information. In other words, a user requesting to access particular information may have security clearances or a security access level that identifies information that the user can access. Generally, this is performed by assigning a security level value to each piece of information or each information type. Users are assigned security access levels which identify security level values that the user is allowed to access. Thus, a user who has a security level equal to or greater than the corresponding security level value of the information, can access the information. Stated conversely, information having a security level value can be accessed by a user who has an equal or greater corresponding security access level.

The secure location profile may also indicate the information or type of information that may be accessible at the secure location. For example, the secure location profile may indicate particular files, data storage locations, particular departments or groups that may access secure information at the particular secure location, particular people or users that can access secure information at the particular secure location, and/or the like, that are able to be accessed from the secure location. For example, a particular department or group within an organization may have associated secure locations. Thus, when someone associated with the department or group wants to access information requiring a secure location, the system may identify that the department or group allows access to the information from the particular location.

As another example, certain users may have particular security access levels that allow access to information requiring a particular security clearance or security access level. These users may have access to a particular secure location. If one of these users accesses the secure location, the system may identify all the information having a security access level equal to or below the security access level of the user and may, thereafter, allow access to this information to this user, assuming the user can be authenticated. Information that requires a secure location but is not accessible from the particular secure location will not be able to be accessed from the secure location. Additionally, or alternatively, the information that may be part of a request to access may identify the secure locations where it can be accessed. Thus, upon accessing or identifying the information to be accessed, the system may determine whether that information is identified as being accessible from the secure location where the request has been received.

At 301, the location authentication system receives a request from a user to access information that is required to be accessed from a secure location. The request can be provided in one or more ways. For example, the request may include a user or other entity providing input to a device that indicates the user wants to access certain information. This input may include a user accessing a data storage location where the information is stored, for example, by activating an application associated with a data storage location where the information is stored, by activating a folder associated with a data storage location where the information is stored, by providing input to a search feature to search for the desired information, by activating an icon corresponding to the information, and/or the like.

As another example, the user may hand carry documents, files, or other physical forms of information that are to be accessed or opened by the user. As another example, the user could scan a barcode, quick response (QR) code, or other code or identifier that corresponds to the desired information which would indicate to the system that the user wants to access the information and would acts as a request to access the information. The request to access information may be received from a device from which the user is attempting to access the information, may be received from a secondary device that may be in communication with the device from which the user will be accessed or in communication with the location authentication system, and/or the like. In other words, the request to access information can be in any format or using any technique that provides an indication to the location authentication system that information having a requirement to be only accessed from a secure location is attempting to be accessed. Additionally, the request can be received from any device that is in communication with the location authentication system and/or the device from which the information is to be accessed.

At 302, the location authentication system determines if the request is being received from a secure location. To determine if the request is being received from a secure location, the system utilizes at least one of a plurality of location authentication techniques available at the secure location. Each of the location authentication techniques includes capturing information using sensors located at the secure location. The location authentication techniques are intended to take the place of geofencing. In other words, instead of relying on GPS signals, as in geofencing, the location authentication techniques of the described system and method rely on sensors and components that are located at the secure location to determine if the request is being received from a secure location. This eliminates the need for the system to have to rely on access to remotely transmitted signals like GPS signals. Instead, the described system and method utilize sensors and Internet of Things (IOT) technology that combine into a single format to give the location authentication system a confidence level that a user is accessing the secure information at the secure location.

The location authentication techniques available at a secure location are at least partially based upon sensors that are located near, at, or within the secure location. For ease of readability, the term sensors will be utilized. However, the term “sensors” is intended to include traditional sensors in additional to components or devices which may not be traditionally recognized as sensors. Some example sensors include image capture devices, health metric sensors, microphones, speakers, radio frequency identification (RFID) receivers and/or transmitters, activity tracking sensors, infrared sensors, and/or the like. Thus, the term “sensors” encompasses any sensor, device, components, and/or the like, that can capture information that can be utilized to determine that a request has been received from a secure location.

Additionally, for ease of readability, the term “at” will be used when referring to the location of the sensors with respect to the secure location. However, it should be understood that “at the secure location” includes any location for a sensor that can be used to detect that a user is at the secure location. Thus, “at the secure location” may include near the secure location, for example, RFID sensors located in a hallway leading to the secure location, badge readers located at a doorway of the secure location, security cameras located outside the doorway of a secure location, and/or the like, in addition to at and within the secure location, for example, security cameras located within the secure location, microphones located within the secure location, and/or the like. Additionally, sensors at the location may not constantly be located at the secure location. For example, some sensors may be located on an information handling device which the user brings into the secure location and takes from the secure location when the user leaves. As another example, some sensors may be located on devices that are worn by the user (e.g., activity tracker, smart watch, etc.) and are, therefore, only within the secure location when the user is within the secure location.

Some location authentication techniques may capture information from sensors located at the secure location and then compare the information received from, accessed from, or otherwise obtained from a second information source. For example, the location authentication system may compare the information captured from the sensors to information captured using a different sensor, information stored within an information source or data storage location (e.g., the user profile, entity or company database, system records, etc.), and/or the like. While many different sensors and location authentication techniques could be utilized, some example location authentication techniques will be described below. However, it should be understood that other authentication techniques that utilize sensors available at a secure location could be utilized.

One location authentication technique includes capturing access information of the secure location that corresponds to the user and comparing a timestamp of the access information to a receipt time of the request. In other words, when a user accesses the secure location, the entrance event may be logged with a time stamp indicating when the user entered the secure location. Similarly, when the user leaves the secure location, the departure event from the secure location may be logged with a time stamp indicating when the user left the secure location. When the request is received, the system may identify a time or timestamp corresponding to the when the request was received. This timestamp can be compared to the entrance event to make sure that the request time is received after the entrance event. Additionally, the system may determine whether a departure event has been received for the user occurring after the entrance event. If so, the system determines if the request time was received before the departure event. In other words, the system determines whether the request is received after the user has entered the secure location, but before the user has left the secure location.

Entrance events and departure events may be logged by virtue of one or more techniques for logging access to locations. For example, when a user accesses a location, the user may have to present an object or code (e.g., a badge, a device generated code, a security access pin or passcode, etc.) to gain entry to the location. As another example, a user may have to perform a biometric scan (e.g., facial scan, fingerprint scan, retinal scan, voice scan, etc.) to gain entry to the location. The system may also track the movement of a user, for example, using RFID tags, using security cameras, using information captured on or from a user device, and/or the like, towards and into a secure location, and upon detecting the user is within the secure location, the system may log an entrance event. Alternatively, or additionally, when a door to a secure location is opened, an entry threshold is crossed, and/or the like, the system may detect this entry point access (e.g., using a security camera, using motion sensors, using light blocking detectors, using infrared sensors, etc.) and log an entrance event.

Similarly, when leaving a secure location, the user may have to perform some action to leave (e.g., present an object or code, perform a biometric scan, etc.), the system may detect the user crossing an entry point, the system may detect the user moving out of and away from the secure location, and/or the like, and log a departure event. Entrance and departure events may be logged within a secure location log, a system log, a security log, and/or the like. Thus, the location authentication system can access these logs or data storage locations to make this comparison. Request time receipts being after an entrance event but before a departure event would result in a positive result from this determination event. Request time receipts that occur before an entrance event or after a departure event would result in a negative result from this determination event.

Another location authentication technique includes presenting a code on a device transmitting the request and capturing, using one or more sensors located at the secure location, the code. In other words, the device that has issued the request to access the secure information may be provide instructions to generate a code on the display of the device. The code may include instructions, a code, a unique identifier, and/or the like, to the device providing the request or location authentication system in order to authorize or verify the request is being transmitted from a secure location. A sensor within the secure location can then capture the code on the display of the device. The code may also include location, a unique user identifier, user login information, and/or the like, that may be processed by the sensor capturing the code, which may allow the sensor or system to authenticate or verify the request is being sent from a secure location. This ensures that the device providing a request is actually located within the secure location because a sensor known to be within the secure location is able to read the code from the display device.

As an example, a user may be utilizing a laptop within the secure location and generate a request to access information from the laptop. In response, the location authentication system provides instructions to the laptop to display a code, for example, a QR code, a barcode, a random machine-generated and machine-readable code, and/or the like, on the display of the laptop. A security camera located within the secure location views the display and recognizes the code or takes an image of the code and transmits it to the location authentication system for analysis and/or verification. Upon determining the code captured by the security camera was the expected code, this location authentication technique results in a match or a verified location result. If a code cannot be captured using a sensor within the secure location or the captured code does not match the expected code, this authentication technique would result in a negative result.

Another location authentication technique includes presenting a code on a device transmitting the request and requesting the user capture the code utilize a device associated with the user. This technique is similar to the previous technique, except instead of a sensor stationed within the secure location (e.g., a sensor that is not removed from the location) capturing the code presented on the device, the user utilizes a device that is associated with the user to capture the code presented on the device. The user may have many different devices that are assigned to the user or otherwise correlated to the user. These devices and associated users may be stored within a data storage location, with the user profile, within the location profile, and/or the like. Accordingly, upon the presentation of the code, the system may prompt the user to utilize one of those devices to capture the code. This assists in ensuring it is the user who is providing the request. Once the user utilizes the user device to capture the code, the information is transmitted from the user device to the location authentication system. In order to make it more difficult to spoof or trick this technique, the system may randomize which user device the user is directed to user to capture the code. A successful capture of the expected code using the user device would result in a positive result from this authentication technique. On the other hand, an unsuccessful capture of the expected code or capture of an unexpected code, or in the case a specific device was requested, use of a different user device, would result in a negative result.

Another location authentication technique includes capturing a first set of attribute information of the user utilizing a device associated with the user and capturing a second set of attribute information of the secure location using at least one of the sensors located with the secure location. The system then compares the first set of attribute information and the second set of attribute information to determine if they match. Stated differently, a user device of the user can capture information that can be matched to information captured by sensors within the secure location. The information captured and matched in this example are attributes of the user. For example, when a user is typing on a keyboard, a device of the user may capture the typing strokes, either via the sound of the typing strokes or based upon the movement of the fingers and/or hands of the user. A microphone or camera within the secure location can capture the sound of the typing or movement of the fingers and/or hands of the user. The system can then compare the typing cadence identified from the information captured by the user device and the typing cadence identified from the information captured by the location sensor. A match would result in a positive result from this authentication technique, whereas a mismatch or no match would result in a negative result from this authentication technique.

As another example, a device of the user could capture the oxygen use or other information which may identify a breathing cadence of the user. A sensor within the secure location (e.g., camera, microphone, etc.) could capture information that identifies a breathing cadence of the user. These two attribute information sets can be compared to determine if they match. A match would result in a positive result from this authentication technique. As a final, non-limiting example, a user device could track steps taken within the secure location which can be compared with activity being captured by sensors within the secure location. A match would result in a positive result from this authentication technique. To be complete, any of these examples in which the comparison does not match, either via a mismatch or no match, would result in a negative result from this authentication technique.

Another location authentication technique includes capturing at least one health metric of the user utilizing a device associated with the user and comparing that health metric to a profile of the user. Many users have devices that are able to capture health metrics of the user, for example, smart watches, activity trackers, computers, and/or the like. Health metrics of the user may include, but are not limited to, heart rate, breathing rate, oxygen level, oxygen saturation, activity, body temperature, and/or the like. The system can communicate with these user devices to obtain these health metrics. Alternatively, or additionally, the secure location may have sensors that can capture health metrics of the user.

The captured health metrics, either from the user device or the sensors located within the secure location, can be compared to the user profile to determine if the user associated with the request is actually the user within the secure location. Additionally, if the health metrics are captured using both sensors from user devices and sensors within the secure location, the system can compare the two health metric values to determine if they match, which would indicate the expected user is within the secure location. Thus, not only can the system determine if the request is being received from a secure location, the system can also determine if the user associated with the request is actually the user providing the request, for example, using this location authentication technique or utilizing other of the location authentication techniques. Additionally, using one or more of the location authentication techniques, the system can determine that the entity within the secure location is a live person, for example, by detecting a heat signature, by detecting a health metric, by requiring the user to capture the code using the user device, and/or the like. Matches between the captured information and user profile and/or the captured information from a user device and a location sensor, would result in a positive result. Mismatches or no matches would result in a negative result.

In making the determination regarding whether a request has been received from a secure location, the system may utilize more than one location authentication technique or a combination of location authentication techniques. The number of authentication techniques that are used for a secure location determination may vary based upon the particular secure location, the information being accessed, settings of the location authentication system, default values, a user providing the request, the available location authentication techniques, and/or the like. How the system makes a determination regarding whether the request has been received from a secure location may be identified within the secure location profile (e.g., how many authentications have to result in a positive match, what information accessible at the secure location requires particular location authentication techniques, users who can access the secure location, etc.).

The location authentication techniques may be weighted with some techniques having higher weightings than others. The weightings may be based upon a confidence level associated with the location authentication technique. For example, one location authentication technique may be more reliable or more accurate at making a secure location determination than another technique. The more reliable or accurate location authentication technique may have a higher weighting than a location authentication technique that is less reliable or accurate. Thus, each of the location authentication techniques and resulting results may have an associated confidence level identifying how accurate the result is or how confident the system is with the result from the technique.

Some possible ways that the location authentication techniques may be aggregated to result in a positive determination (i.e., the location authentication system indicates the request is being received from a secure location) include, but are not limited to, a majority of the available location authentication techniques for a secure location, a particular overall weighting of selected location authentication techniques, a particular percentage or fraction of available location authentication techniques for a secure location, all of the available location authentication techniques, a certain number of location authentication techniques regardless of the number of available location authentication techniques, and/or the like.

For example, for a particular secure location having five available authentication techniques, it may be set that three out of the five authentication techniques have to result in a positive result (e.g., the location authentication technique indicates a match to a comparison value, the location authentication technique indicates that particular authentication technique indicates the request was received from the secure location, etc.) before the system will determine that the request was received from a secure location. As another example, for a particular user may be within a secure location having four available authentication techniques with an overall weighting of 100. Each of the individual authentication techniques being weighted at a portion of the 100, which may or may not be equally distributed across the authentication techniques. If the authentication techniques returning a positive result have an aggregated weighting of at least 60, the system may determine that the request was received from a secure location.

If, at 302, the location authentication system determines that the request is not received from a secure location, the system denies access to the information at 304. Determining that the request was not received from a secure location may include one or more of the location authentication techniques returning a negative result. Alternatively, in the event that more than one location authentication technique is utilized, determining the request was not received from a secure location may include the number of positive results, the percentage of positive results, the weight of the positive results, or whatever criteria the system utilizes to designate that the request was received from a secure location, does not meet the criteria. In other words, the negative results result in the system not meeting the criteria required to designate that the request was received from a secure location.

The system may also determine that the request is not received from a secure location if one or more of the location authentication techniques cannot determine a result, either positive or negative. A no result from an authentication technique may be treated as a negative result for the purposes of identifying whether the positive results meet the predetermined criteria for identifying if a request was received from a secure location. The location authentication system may deny access to the information if the system determines that the request was not received from a secure location regardless of whether the user is able to be authenticated utilizing other authentication techniques. For example, even if the user is successfully authenticated as a user who has access to the information using biometric scans, user credentials, two-factor authentication, and/or the like, if the system determines the request is not received from a designated secure location, the system may deny access to the information.

If, on the other hand, the location authentication system determines that the request is being received from a secure location at 302, the system grants access to the information at 303. The location authentication system may determine that the request is being received from a secure location if the criteria or threshold for such a determination is met. In other words, if the number or volume of positive results result in the criteria being met (e.g., a certain percentage, a majority, a particular fraction of results, a particular weighting of results, etc.) the system determines that the request has been received from a secure location. If the request has been received from a secure location, the system grants access to the information included in the request.

In granting access to the information, the system may also determine that the user has been authenticated as a user who is allowed access to the information. Authenticating the user in this manner may be performed using what is generally considered a strong authentication technique. Strong authentication techniques are authentication techniques that require the provision of credentials, biometric information, coded identification tags, two-factor authentication, or other information or objects which are difficult to replicate and which more accurately ensure that a person providing the authentication is actually the person who corresponds to the authentication. In other words, strong authentication techniques are authentication techniques that verify an identity of a person and can verify whether the identity of the person matches an authorized user.

Fingerprint scans, iris or retinal scans, user credentials (e.g., login name and password, etc.), two-factor authentication, badge or key swipes or presentation, voice passwords, and/or the like, are considered strong authentication techniques. Thus, the granting of access to the information of the request may be responsive to not only determining that the request was received from a secure location, but may also be responsive to determining the user has been authenticated using one or more strong authentication techniques. In other words, the system may only grant access if the request is received from a secure location and the identity of the user can be verified and the user is authorized to access the requested information. Some of the location authentication techniques can also be used to assist in determining an identity of the user which may be used to verify a strong authentication technique result.

After the user is granted access to the information, an authenticated session is established. An authenticated session is a session where the user has been granted access to information after being authenticated. An authenticated session continues until a termination event is received, which may include the user terminating the authenticated session (e.g., logging out, leaving the secure location, etc.), the system terminating the authenticated session (e.g., detecting an event that indicates the session should be terminated, the system being unable to continuously authenticated the user, etc.), and/or the like. During the authenticated session, the location authentication system may perform continuous authentication of the user. The continuous authentication ensures that the user who started the authenticated session is the user who remains in the secure location while the authenticated session is ongoing.

As previously mentioned, the continuous authentication may occur at a predetermined frequency during the authenticated session, for example, constantly, every few seconds, every few minutes, multiple times an hour, hourly, and/or the like. To perform the continuous authentication, the system may utilize any type of continuous authentication technique. Additionally, the system may utilize one or more of the location authentication techniques described herein. It should be noted that the location authentication technique or techniques that were used to determine whether the request was received from a secure location can be different than the location authentication technique or techniques chosen to perform the continuous authentication. For example, the determination the request was received from a secure location was based upon attribute matching, access information compared against request time receipt, and biometric matching, but the continuous authentication may be based upon code presentation that must be captured by a user device.

Additionally, for the continuous authentication a number of location authentication techniques that result in a positive result may be different than the number required to determine the request was received from a secure location. For example, the determination that the request was received from a secure location was based upon a positive result from three out of five location authentication techniques, but the continuous authentication may be performed utilizing just a single location authentication technique. The system may also rotate through the location authentication techniques while performing the continuous authentication. Additionally, in the event that a location authentication technique results in a negative result, the system may attempt to use a different location authentication technique to perform the continuous authentication before determining that the user cannot be authenticated. Upon determining that the user cannot be authenticated using the continuous authentication, the system may terminate the authenticated session, may require the user to provide authentication using a strong authentication technique, may provide a notification to an entity or security team, and/or the like.

As an overall non-limiting example of the described system, a user may be a person within a company that has a security clearance that allows this user to access highly sensitive information. However, the highly sensitive information can only be accessed from a particular secure location, for example, a room within the building of the company. This room includes a badge reader to which a user has to present a badge of the user. If the badge is assigned to a user with the appropriate security level for accessing the room, the person with the badge is granted access to the room. Within the room, the user can access a device that will provide access to the desired information. In this example, the device will be a laptop computer that the user has carried with them into the room. Accordingly, the user activates the laptop within the room and provides an indication of the information the user wants to access, thereby generating a request to access information that is required to be accessed from a secure location.

Upon receiving the request, the system determines whether the request has been received from a secure location using one or more location authentication techniques available at the secure location. In this example, this secure location will have three possible location authentication techniques available. The first is a badging location authentication technique where the system identifies whether the user who is attempting to access the information has presented an assigned badge at the badge reader of the secure location (referred to as “badging-in”) and has not yet “badged-out,” meaning the user has not presented a badge at the badge reader to leave the secure location before the request has been received at the system.

The second technique is a quick response (QR) code presentation technique. In this technique, a QR code is presented on the laptop of the user and a security camera within the secure location reads the QR code from the laptop. The third technique is an attribute matching technique. The example attribute matching technique used for this example will be a typing cadence attribute, where a smart watch of the user will identify a typing cadence of the user based upon the sound of the typing. This typing cadence will be compared to a typing cadence identified at the secure location using images captured with the security camera. In this example, all three location authentication techniques will need to be matched before the system will determine the request was received from the secure location.

As should be understood, these are three techniques that have been chosen for this example, but are not the only possible location authentication techniques. Nor are three authentication techniques intended to be a limiting number of the authentication techniques for a particular location. Additionally, in this example, all location authentication techniques need to be matched. However, this is not limiting, as fewer than all may be matched and still result in a positive determination that the request was received from a secure location.

For this example, the system determines that the request has been received before the user has badged-out of the secure location but after the user has badged-into the secure location. Additionally, the security camera within the secure location can capture and read the QR presented on the laptop, thereby indicating at least the laptop corresponding to the badged-in user is present within the secure location. Finally, the system determines that the typing cadence captured by the smart watch of the user matches the typing cadence determined from the images captured by the security camera within the secure location. Thus, the system determines that the request has been received from the secure location without the use of geofencing. Accordingly, the system grants access to the information to the user. For completeness, in this example, the user has also provided a fingerprint scan that has authenticated the user as a user that can access the information before the user is allowed to access the information. In the event that one of the location authentication techniques failed, the user would be prevented from accessing the secure information.

Additionally, once the user has been authenticated and granted access to the information, an authenticated session is established. During this authenticated session, the system utilizes one or more of the location authentication techniques to perform continuous authentication of the user until the system or user terminates the authenticated session. In this example, the system verifies that during the authenticated session a badge-out event has not been received and the typing cadence identified by the smart watch of the user continues to match the typing cadence identified from images captured by the security camera(s) within the secure location. Additionally, periodically, the system presents a QR code on the laptop display to be captured by the security cameras. As long as these authentication techniques continue to result in positive matches, the authenticated session will continue. Upon detection of a failure, the authenticated session may be terminated, the user may be requested to provide additional authentication information, the system may perform more or different location authentication techniques, and/or the like. While the same location authentication techniques were used for the continuous authentication and the location authentication, it should be noted that the system does not have to use the same techniques for both authentications, nor does the same number of techniques need to be used for the authentications.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
receiving, utilizing a location authentication system, a request from a user to access information required to be accessed from a secure location;
determining, utilizing the location authentication system, the request has been received from the secure location utilizing at least one of a plurality of location authentication techniques available at the secure location, wherein each of the plurality of location authentication techniques comprises capturing information using sensors located at the secure location; and
granting, utilizing the location authentication system and responsive to determining the request has been received from the secure location, access to the information to the user.

2. The method of claim 1, wherein the determining comprises capturing information from each of the plurality of location authentication techniques, comparing the captured information to information from at least one second information source, and identifying, based upon the comparing, the information captured from a predetermined number of the plurality of location authentication techniques matches the information from a second information source.

3. The method of claim 1, wherein one of the plurality of location authentication techniques comprises capturing access information of the secure location and corresponding to the user and comparing a timestamp of the access information to a receipt time of the request.

4. The method of claim 1, wherein one of the plurality of location authentication techniques comprises presenting a code on a device transmitting the request and capturing, using at least one of the sensors located at the secure location, the code.

5. The method of claim 1, wherein one of the plurality of location authentication techniques comprises presenting a code on a device transmitting the request and requesting the user capture the code utilizing a device associated with the user.

6. The method of claim 1, wherein one of the plurality of location authentication techniques comprises capturing at least one health metric of the user utilizing a device associated with the user and comparing the at least one health metric with a profile of the user.

7. The method of claim 1, wherein one of the plurality of location authentication techniques comprises capturing a first set of attribute information of the user utilizing a device associated with the user, capturing a second set of attribute information of the secure location utilizing at least one of the sensors located within the secure location, and comparing the first set of attribute information and the second set of attribute information.

8. The method of claim 1, comprising authenticating the user utilizing at least a subset of the plurality of location authentication techniques at a predetermined frequency during an authenticated session established responsive to the granting.

9. The method of claim 1, wherein the granting is responsive to determining the user has been authenticated utilizing a strong authentication technique.

10. The method of claim 1, wherein the determining does not utilize geofencing location identification techniques.

11. A system, the system comprising:
sensors located at a secure location;
a processor operatively coupled the sensors;
a memory device that stores instructions that, when executed by the processor, causes the system to:
receive, utilizing a location authentication system, a request from a user to access information required to be accessed from a secure location;
determine, utilizing the location authentication system, the request has been received from the secure location utilizing at least one of a plurality of location authentication techniques available at the secure location, wherein each of the plurality of location authentication techniques comprises capturing information using the sensors located at the secure location; and
grant, utilizing the location authentication system and responsive to determining the request has been received from the secure location, access to the information to the user.

12. The system of claim 11, wherein the determining comprises capturing information from each of the plurality of location authentication techniques, comparing the captured information to information from at least one second information source, and identifying, based upon the comparing, the information captured from a predetermined number of the plurality of location authentication techniques matches the information from a second information source.

13. The system of claim 11, wherein one of the plurality of location authentication techniques comprises capturing access information of the secure location and corresponding to the user and comparing a timestamp of the access information to a receipt time of the request.

14. The system of claim 11, wherein one of the plurality of location authentication techniques comprises presenting a code on a device transmitting the request and capturing, using at least one of the sensors located at the secure location, the code.

15. The system of claim 11, wherein one of the plurality of location authentication techniques comprises presenting a code on a device transmitting the request and requesting the user capture the code utilizing a device associated with the user.

16. The system of claim 11, wherein one of the plurality of location authentication techniques comprises capturing at least one health metric of the user utilizing a device associated with the user and comparing the at least one health metric with a profile of the user.

17. The system of claim 11, wherein one of the plurality of location authentication techniques comprises capturing a first set of attribute information of the user utilizing a device associated with the user, capturing a second set of attribute information of the secure location utilizing at least one of the sensors located within the secure location, and comparing the first set of attribute information and the second set of attribute information.

18. The system of claim 11, comprising authenticating the user utilizing at least a subset of the plurality of location authentication techniques at a predetermined frequency during an authenticated session established responsive to the granting.

19. The system of claim 11, wherein the determining does not utilize geofencing location identification techniques.

20. A product, the product comprising:
a computer-readable storage device that stores executable code that, when executed by a processor, causes the product to:
receive, utilizing a location authentication system, a request from a user to access information required to be accessed from a secure location;
determine, utilizing the location authentication system, the request has been received from the secure location utilizing at least one of a plurality of location authentication techniques available at the secure location, wherein each of the plurality of location authentication techniques comprises capturing information using sensors located at the secure location; and
grant, utilizing the location authentication system and responsive to determining the request has been received from the secure location, access to the information to the user.
